(19) United States
(12) Patent Application Publication
(10) Pub. No.: US 2015/0309754 A1
(43) Pub. Date: Oct. 29, 2015

(54) System and Method for Erasing Data on an Electronic Device

(71) Applicant: Michael Smithwick, San Jose, CA (US)

(72) Inventor: Michael Smithwick, San Jose, CA (US)

(21) Appl. No.: 14/664,428

(22) Filed: Mar. 20, 2015

Related U.S. Application Data
(60) Provisional application No. 61/983,899, filed on Apr. 24, 2014.

(51) Int. Cl. G06F 3/06; H02J 7/00; G06F 1/26

(52) U.S. Cl. CPC G06F 3/0652; G06F 3/0608; G06F 3/0673; G06F 1/26; H02J 7/0036; H02J 7/0052

(57) ABSTRACT

A data erasing system and method for erasing the data on multiple electronic devices at a time, where the multiple electronic devices do not all have to be of the same type or connected at the same time, and where the electronic device's battery may be dead prior to erasure.

### CROSS-REFERENCE TO RELATED APPLICATIONS

The present application takes priority from Provisional Application No. 61/983,899, filed Apr. 24, 2014, which is herein incorporated by reference.

### STATEMENT REGARDING FEDERALLY SPONSORED RESEARCH AND DEVELOPMENT

Not Applicable.

### BACKGROUND

1. Field of the Invention

The present invention relates generally to recycling electronics, and more specifically, to a system and method for erasing data on an electronic device.

2. Description of the Related Art

Due to the rapid evolution of electronic devices, consumers often have an excess of old, unwanted electronic devices cluttering up their homes. Such devices may include cell phones, PDA's, smartphones, GPS devices, calculators, mp3 players, and other similar electronics.

Many facilities exist for processing used electronic devices and refurbishing them for resale. One important function that such a facility has to perform is erasing any personal data from the used electronic device. This is important for consumer security and for rendering the device suitable for resale.

Typically, erasing the data on an electronic device is accomplished by means of a USB connection to a computer. However, if a used electronic device has a dead battery (as many used electronic devices do after being left in a desk drawer for a few months, or after being in transit to a facility), a USB connection will not be able to deliver enough power to power on the device in order to erase it; in fact, a dead device will not even register on such a system.

A need therefore exists for a system that can detect the presence of a dead electronic device when it is connected to the system, deliver sufficient power to the electronic device to enable it to power on, and erase personal data from the electronic device.

### SUMMARY OF THE INVENTION

An object of the present invention is to provide a system and method for erasing the data from an electronic device, regardless of whether or not the electronic device's battery is charged at the start of the erasure process.

Another object of the present invention is to provide a system and method for erasing the data from an electronic device, comprising providing sufficient current to charge the battery on the electronic device prior to the erasure process.

Another object of the present invention is to provide a system and method for erasing the data from an electronic device while charging the battery to the minimum acceptable level during the erasure process.

The system of the present invention preferably comprises a power module for delivering power to an electronic device sufficient to charge the battery on the electronic device, a communication module for communicating with the Internet, and a processor and memory, said processor being configured to detect whether or not an electronic device is connected to the system, detect whether or not the electronic device's battery is charged (and charge it if it is dead), detect the manufacturer, model, and operating system of the electronic device, erase data on the electronic device, and generate a certificate of erasure. The system can perform these actions on multiple electronic devices.

The detection of whether or not an electronic device is connected to the system can be done by grounding a wire.

The system may request permission from the service provider associated with the electronic device and only erase the data on the electronic device once this permission is received.

The system may also perform a functional or cosmetic test on the electronic device prior to, or after, erasing the data on the electronic device.

The method of the present invention preferably comprises detecting whether an electronic device is connected (whether or not the battery on the electronic device is dead), identifying the electronic device, detecting whether its battery is charged and charging it, and erasing the data and generating a certificate of erasure. In the preferred embodiment, the charging of the battery is only done to a level of charge necessary to erase the data on the device (not necessarily to 100%).

In an embodiment, the method of the present invention also comprises asking a service provider associated with the electronic device for permission to erase the data on the electronic device. Once the permission is received, it is incorporated in the certificate of erasure (along with a time/date stamp).

### LIST OF FIGURES

FIG. 1 shows a block diagram of the system of the present invention.

FIG. 2 shows a flowchart showing the erasure process of the present invention.

FIG. 3 shows an embodiment of the system of the present invention.

### DETAILED DESCRIPTION OF THE PREFERRED EMBODIMENT

The steps and elements described below do not all have to be present in an embodiment of the invention. As is evident to a person of reasonable skill in the art, the invention can be implemented with only one, or only a few, of the below-described elements. While the preferred embodiment contains all of the below elements, other embodiments may comprise some but not others.

The devices that can be erased by a system of the present invention can be smartphones, cell phones, mp3 players, tablets, gaming devices, and other mobile devices that have a memory that may need to be erased if the device changes ownership.

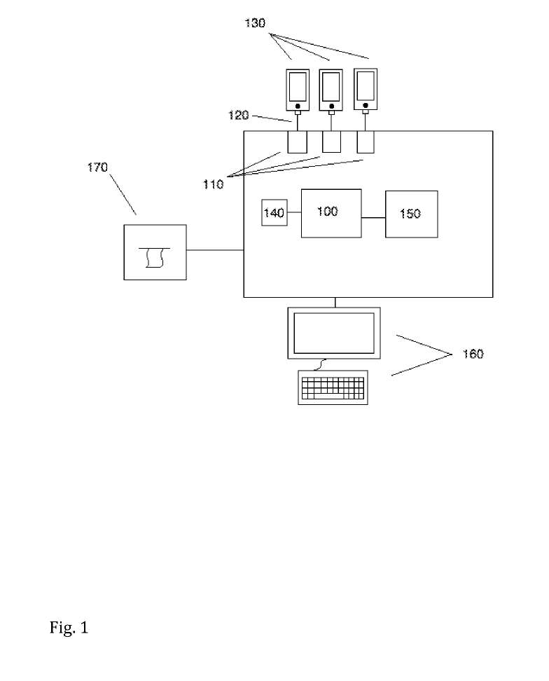

FIG. 1 shows a block diagram of the system of the present invention. In the preferred embodiment, a system of the present invention comprises a processor 100, memory 150, device connectors 120 for multiple electronic devices 130, a user interface 160 (a screen and keyboard, as well as hardware buttons) or a tablet connected by wire or wirelessly, and a label printer 170. The system is capable of operating automatically or in manual mode, where the operator would trigger each subsequent step in the process after the completion of the preceding step.

In the diagram, only 3 electronic devices 130 are shown as connected to the system; however, the system may be designed for any number of electronic devices. Processor 100 controls the operation of the system. Device detection circuit 110 is connected to each device connector 120. When an electronic device 130 is connected to a device connector 120, the device detection circuit 110 detects the presence of the device.

Device detection circuit 110 preferably operates by grounding a wire. This means that it will be able to detect an electronic device connected to the system even if the battery on the electronic device is completely dead. This is advantageous since many consumers let the battery on an old electronic device die completely before it ever gets to a refurbishing facility, or the battery can die while the device is in transit to the facility. Once an electronic device is detected, the processor 100 queries the electronic device to determine what type of device it is, what its operating system is, and what level of charge the battery has.

The processor also references a database stored in the memory 150 of how much charge the battery of a device of a given type requires before it can be erased. For example, a particular type of device may only need a battery charged to 25% before it can function well enough to have its data erased, while a different type of device may need a battery charged to 30%. Finally, the processor also determines how much current is required to charge the battery on the particular electronic device.

Power circuit 140 delivers power to the electronic device 130, preferably at a constant current. Once the processor 100 determines how much current is required to charge the battery and to what level the battery needs to be charged, it directs the power circuit 140 to deliver that amount of current to the electronic device until the battery is charged to the desired level. This may be done for multiple devices simultaneously.

In the preferred embodiment, the power circuit 140 delivers 3 amps of current into the device, rather than the 2 amps used in the prior art. In an alternate embodiment, the processor 100 determines the maximum allowable charging current that can be delivered to the device without damaging the battery, and directs the power circuit 140 to deliver that amount of current to the device.

In the preferred embodiment, the voltage of the battery is monitored during the charging process by the power circuit 140. The processor 100 determines the minimum voltage amount that is sufficient to erase the data on the electronic device for the particular type of electronic device, and when that minimum voltage amount is reached, the charging process stops.

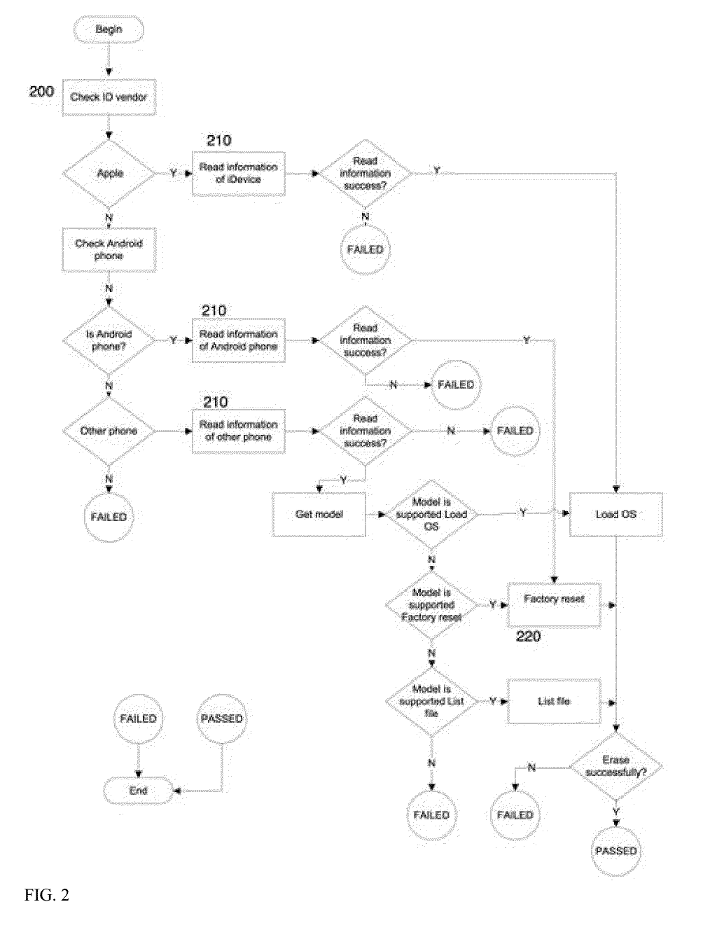

One embodiment of the erasure process is outlined in FIG. 2. The system first checks 200 to determine the type of device that is connected to the system; whether it is an Apple device, an Android device, or some other device altogether. The system then reads the information of the device 210. In the case of the “other phone”, it also determines the model of the phone. Once it reads the information, it performs a factory reset 220 on the device.

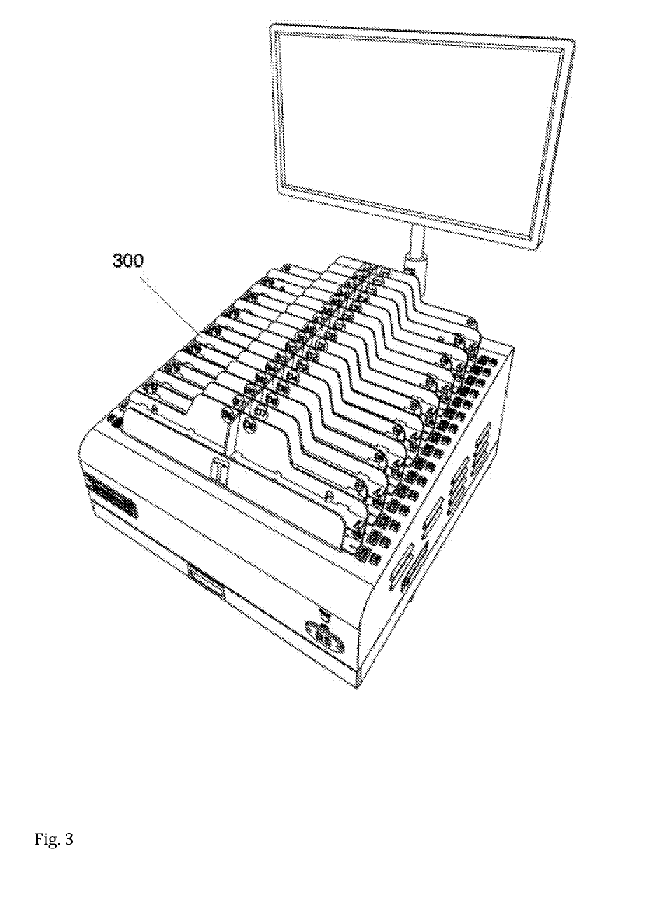

As is shown in FIG. 3, the system preferably comprises a device holder mechanism 300 that can hold up to 256 units of mobile devices and that can connect one device at a time to the data erasing circuitry while disconnecting others. In its preferred embodiment, the system maintains a state for each device, each state consisting of discrete steps in the process, each state maintaining the current incremental step and providing the next incremental step in the overall process. Each step may be determined by previous steps or may be independent of previous steps, the system able to maintain independence and asynchronous functionality between devices. In its preferred embodiment, the system connects to one device, performs one step in the erasure process, then disconnects from that device, connects to another device, performs one step in the erasure process, and so on, cycling through all the devices plugged into the system. The steps do not all have to be the same; the system keeps track of where each device is in the erasure process, and automatically queues up the next step for that device. So, for example, the system can perform the first step in erasing Device #1, then go on to Device #2, which is already four steps into the process, and perform the fifth step in erasing that device; then go on to Device #3, which is one step into the process, and perform the second step in erasing that device; and so on. The sequential order of the devices processed is not important, and devices may be skipped if they are busy and not ready to be processed.

The steps of the process may be any subdivisions in the process of erasing the data on an electronic device, such as “identification of the device”, “determine if the device is ready”, “send a command to erase the address book”, “erase address book”, “erase all apps”, and so on. Any steps known to a person of reasonable skill in the art can be used for purposes of the present invention. It must be noted that some of the steps in the process are done automatically by the electronic device itself, while some other steps must be performed by the system on the electronic device.

The system preferably comprises a state machine that keeps track of where each electronic device is in the erasing process. Each time the system switches from one electronic device to another, it looks up the status of the electronic device and performs the next step in the process for that device. This enables the system to perform erasing asynchronously.

Note that while some steps in the erasing process must be performed in a specific order, some other steps may be performed in any order (for example, it's not necessary to erase the address book before erasing the calendar). The system of the present invention preferably performs the steps in the same order on each device; the order of the steps can be pre-programmed into the system. This simplifies operations. However, the order or nature of the steps may be different for different types of devices (for example, not every device may even have an address book or a calendar, or different types of devices may have different orders of steps). Also, different cell phone carriers may have different configurations for the same type of device. In this case, the system of the present invention can keep track of what steps in what order are required for each device connected to it, and where each device is in the process.

In its preferred embodiment, the system offers three different methods of erasing the data on a device. In the “OS reload” method, the system loads new OS firmware onto the device overwriting all previous data and blank space. In the “personal data wipe” method, the system keeps the apps installed on the device, but cleans out personal information such as the address book, calendar, and any personal data present in the device. In the “device restore” method, the system removes the apps and removes any native data in the device, but does not upgrade the firmware or operating system. Other methods of erasure may also be available in other embodiments.

In the preferred embodiment, the system generates a certificate of erasure for every electronic device erased. Such a certificate of erasure may include information such as a time/date stamp, type of device, location of the facility, batch ID of the batch of devices erased at that time, identification of the machine used to erase the electronic device, identification of the electronic device, and other pertinent information. The certificate of erasure may then be provided to the former owner of the device, the service provider associated with the device, the refurbisher, or any other person or entity that may need to have proof that the personal data on the electronic device was erased.

In the preferred embodiment, the system queries the service provider associated with each device for permission to erase the data on the device prior to erasing the data. The service provider may verify that the user had, in fact, resold the device, that the device is not stolen, and that the device no longer belongs to the user and thus may be erased. The system may then incorporate the verification into the certificate of erasure, including the time/date stamp, so that it can be seen that the service provider has granted permission to erase the data on the device.

In an embodiment, the system also comprises a battery tester that can perform nondestructive battery testing on any of the electronic devices connected to the system while the battery remains attached to the device. In its preferred embodiment, the battery tester will determine if the battery requires an electrical charge, charge the battery to a user determined level if required, perform testing to a reliability level determined by the user, record data related to the testing, and provide a user determined result. In its preferred embodiment, the battery test combines statistical and physical parameters to determine the status of the battery. Statistical parameters consist of a comparison of premature battery test results versus known mature results of the same test duration, where the comparison is used with a test population to determine the probable status of the battery, the premature test duration being determined by the machine user. In the preferred embodiment the physical parameters used to determine battery health are charge rate, discharge rate, and charge hold time tested to varying durations and levels, but other methods may also be added to further determine the health of the battery.

The system may also comprise a module, or software, for performing functional testing on any electronic device or devices connected to the system. Such functional testing may test functions such as the screen, the cellular phone function, the touchscreen, the buttons, the wi-fi connection, and so on. In some embodiments, the functional testing may require the operator to interact with the electronic device (for example, in order to test the buttons). In some embodiments, only those functions that can be tested without operator interaction may be tested (for example, the wi-fi connection).

In an embodiment, the system may perform a cosmetic evaluation on each device. In the preferred embodiment, this cosmetic evaluation is performed by photographing the device using the device's own camera in front of a mirror. The operator may be directed to hold the mirror and the device in the correct relative positions to each other, and photos of the device may be taken. Afterwards, the photos are processed and evaluated to determine the number and type of cosmetic imperfections on the device. Such cosmetic imperfections may be scratches, cracks, or scuffs. The system then generates a cosmetic condition score based on the number and type of cosmetic imperfections.

In an embodiment, the function of the system can be monitored and controlled remotely. For example, the batch ID can be set remotely; the association table can be loaded remotely; and so on. In an embodiment, the entire process may be monitored over a website in real time.

The system is preferably connected to the cloud. In an embodiment, the system uses its cloud connection to set the individual cost for erasure, to allow for remote monitoring and control, and to permit external storage of erasure certificates and other data related to the erasure.

While the preferred embodiment is described above, other embodiments may also be included in the scope of the invention, as is evident to one skilled in the art. The limitations of the invention are set forth in the appended claims.

1. A system for erasing data on an electronic device, comprising:
at least one power module for delivering power to an electronic device, said power module capable of delivering sufficient current to charge a battery on said electronic device;
a communication module to enable the system to communicate with the Internet;
a processor and memory, said processor being configured to:
detect whether or not an electronic device is connected to the system regardless of whether the electronic device has a dead battery;
detect whether the electronic device's battery is charged and cause the power module to charge the electronic device's battery if it is not charged;
detect the manufacturer, model, and operating system of the electronic device;
erase data on the electronic device;
generate a certificate of erasure.

2. The system of claim 1, wherein the processor detects whether or not an electronic device is connected to the system by grounding a wire.

3. The system of claim 1, wherein the power module and the processor are capable of processing multiple electronic devices.

4. The system of claim 3, further comprising a user interface comprising one illuminated button for each electronic device connected to the system.

5. The system of claim 1, wherein the power module comprises:
a charging circuit that generates a constant current at the maximum amount that can be tolerated by the electronic device;
a circuit that monitors the voltage of the battery of the electronic device and stops the charging process when the minimum voltage sufficient for erasing the data on the electronic device is reached.

6. The system of claim 1, wherein the processor is also configured to:
perform a functional test on the electronic device.

7. The system of claim 1, wherein the processor is also configured to:
perform a cosmetic test on the electronic device.

8. The system of claim 1, wherein the processor communicates with a service provider associated with the electronic device and asks for permission prior to erasing the data on the electronic device.

9. The system of claim 8, wherein the processor receives a permission from the service provider and incorporates the permission into the certificate of erasure.

10. The system of claim 1, wherein the processor is configured to determine how much power an electronic device requires in order to charge the battery, and to direct the power module to charge the battery.

11. A method of erasing the data on an electronic device, comprising:
detecting whether an electronic device is connected;
identifying the electronic device;
detecting whether the battery on the electronic device is charged;
charging the battery if it is not sufficiently charged to erase the device;
erasing the data on the electronic device;
generating a certificate of erasure.

12. The method of claim 11, further comprising:
asking a service provider associated with the electronic device for permission to erase the data on the electronic device;
receiving permission to erase the data on the electronic device;
incorporating the permission in the certificate of the erasure.

13. The method of claim 12, wherein the permission includes a time and date stamp.

14. The method of claim 11, wherein charging the battery comprises:
determining the minimum charge necessary to erase the device;
charging the battery to the minimum charge.

15. The method of claim 11, further comprising:
performing a functional test on the electronic device.

16. The method of claim 11, further comprising:
performing a cosmetic test on the electronic device.
